(19) United States
(12) Patent Application Publication
(10) Pub. No.: US 2024/0394584 A1
(43) Pub. Date: Nov. 28, 2024

(54) Surface Code Computations using ISWAP Gates

(71) Applicant: Google LLC, Mountain View, CA (US)

(72) Inventors: Craig GIDNEY, Goleta, CA (US); David BACON, Seattle, WA (US)

(21) Appl. No.: 18/411,407

(22) Filed: Jan. 12, 2024

Related U.S. Application Data
(60) Provisional application No. 63/479,642, filed on Jan. 12, 2023.

(51) Int. Cl. G06N 10/70; G06N 10/20; G06N 10/40

(52) U.S. Cl. CPC G06N 10/70; G06N 10/20; G06N 10/40

(57) ABSTRACT

Methods, systems, and apparatus for implementing a surface code cycle using iswap gates. In one aspect, a method includes applying a first entangling operation between a measure qubit in a ground state and a first data qubit, where the first entangling operation comprises a first iSWAP gate in sequence with the application of at least one other operation such that a result of applying the first entangling operation between the measure qubit and the first data qubit is equivalent to a result of applying a CZ gate between the measure qubit and the first data qubit; applying a second iSWAP gate between the measure qubit and a second data qubit; applying a third iSWAP gate between the measure qubit and a third data qubit; applying a second entangling operation between the measure qubit and a fourth data qubit; and measuring the measure qubit to detect errors.

### CROSS-REFERENCE TO RELATED APPLICATION

This application claims the benefit under 35 U.S.C. § 119(e) of U.S. Patent Application No. 63/479,642, filed Jan. 12, 2023. The disclosure of the foregoing application is incorporated herein by reference in its entirety for all purposes.

### BACKGROUND

This specification relates to quantum computing.

Quantum computing provides a means to solve certain problems that cannot be solved in a reasonable period of time using conventional classical computers. These problems include factoring very large numbers into their primes and searching large, unstructured data sets. A number of physical systems are being explored for their use in quantum computing, including ions, spins in semiconductors, and superconducting circuits. However, none of these systems perform sufficiently well to serve directly as computational qubits. For example, single two-state physical systems, which can be used as physical qubits, cannot reliably encode and retain information for long enough to be useful.

Therefore, scalable quantum computers require quantum error correction. Classical error correction employs redundancy. For example, in the repetition code information is copied and stored multiple times. If the copies are later found to disagree, it can be determined that an error has occurred and a majority vote can be taken to recover the information. Copying quantum information is not possible due to the no-cloning theorem. Therefore, quantum error correction codes spread the logical information of one qubit onto an entangled state of multiple physical qubits. The multiple physical qubits are collectively referred to as a logical qubit.

Surface codes are a family of quantum error correcting codes that are defined on a two-dimensional grid of qubits. In the surface code, physical qubits are entangled using a sequence of physical qubit CNOT operations, with subsequent measurements of the entangled states providing a means for error correction and error detection. A set of physical qubits entangled in this way is used to define a logical qubit, which due to the entanglement and measurement has far better performance than the underlying physical qubits. One of the significant advantages of surface codes is their relative tolerance to local errors. Surface codes can handle error rates of almost 3% per surface code clock cycle, which is far less stringent than that of other quantum computing approaches. This error tolerance, along with the simple two-dimensional qubit layout, makes a surface code architecture a realistic approach to building a solid-state quantum computer.

### SUMMARY

This specification describes technologies for building the surface code using iSWAP gates.

One innovative aspect of the subject matter described in this specification can be implemented in a method that includes performing a first surface code cycle in a system comprising a plurality of physical qubits arranged on a grid, wherein performing the first surface code cycle comprises: applying a first entangling operation between a measure qubit in a ground state and a first data qubit, wherein the first entangling operation comprises a first iSWAP gate in sequence with the application of at least one other operation such that a result of applying the first entangling operation between the measure qubit in the ground state and the first data qubit is equivalent to a result of applying a CZ gate between the measure qubit in the ground state and the first data qubit; applying a second iSWAP gate between the measure qubit and a second data qubit; applying a third iSWAP gate between the measure qubit and a third data qubit; applying a second entangling operation between the measure qubit and a fourth data qubit, wherein the second entangling operation comprises a fourth iSWAP gate in sequence with the application of at least one other operation such that a result of applying the second entangling operation to the measure qubit and the fourth data qubit is equivalent to a result of applying a CZ gate between the measure qubit and the fourth data qubit; and measuring the measure qubit to detect errors.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations applying the first entangling operation further comprises applying one or more single qubit gates to the measure qubit and to the first data qubit.

In some implementations applying one or more single qubit gates to the measure qubit comprises applying a Hadamard gate to the measure qubit prior to applying the first iSWAP gate.

In some implementations applying one or more single qubit gates to the measure qubit and to the first data qubit comprises, after applying the first iSWAP gate: applying an inverse S-gate to the measure qubit and to the first data qubit; and applying a Hadamard gate to the first data qubit.

In some implementations applying the second entangling operation comprises, prior to applying the fourth iSWAP gate, applying a Hadamard gate to the fourth data qubit.

In some implementations applying the second entangling operation comprises, after applying the fourth iSWAP gate: applying an inverse S-gate to the measure qubit and the fourth data qubit; and applying a Hadamard gate to the measure qubit.

In some implementations the method further comprises, prior to applying the first entangling operation, applying a reset operation to the measure qubit to reset the measure qubit in the ground state.

In some implementations performing the first surface code cycle moves information encoded by the measure qubit and the first data qubit, second data qubit, third data qubit, and fourth data qubit to other qubits in the grid.

In some implementations information encoded by the measure qubit moves to other qubits in the grid in a first direction and information encoded by one or more of the first data qubit, second data qubit, third data qubit, or fourth data qubit moves to other qubits in the grid in a second direction, wherein the second direction is opposite to the first direction.

In some implementations information encoded by the measure qubit and data qubits coupled to the measure qubit in a third direction that is perpendicular to the first direction collectively moves in the grid.

In some implementations the method further comprises performing a second surface code cycle, wherein performing the second surface code cycle comprises performing the first surface code cycle in reverse order.

The subject matter described in this specification can be implemented in particular ways so as to realize one or more of the following advantages.

Some quantum hardware can perform iSWAP gates more efficiently and reliably compared to other two-qubit gates such as CNOT or CZ gates. For example, iSWAP gates typically introduce less calibration constraints than CZ gates. The presently described circuit schedules are particularly adapted for such quantum hardware and provides a new surface code compilation that uses iSWAP gates instead of CNOT or CZ gates. Further, the presently described circuit schedules are designed such that logical movement of qubits (i.e., movement of information in the qubit array) is reduced, reducing the amount of qubit padding needed for the information to drift into (and therefore optimizing the amount of required computational resources). Further, the circuit schedules alternate between two different surface code cycles such that the logical movement of qubits oscillates around a center position and does not drift in one direction (which also optimizes the amount of required computational resources since less space is required).

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for implementing an iSWAP surface code.

FIG. 2 is a flowchart of an example process for performing an iSWAP surface code cycle.

FIGS. 3A and 3B show example quantum circuits for implementing a first and second entangling operation.

FIG. 4 illustrates example quantum circuit layers for performing an iSWAP surface code cycle.

FIG. 5 is an illustration that shows how information encoded by qubits included in the surface code patch moves.

FIGS. 6A-G illustrate interactions performed by a measure qubit and tracks the movement of information accumulated by the measurement.

FIG. 7 shows example qubit grid paddings for the movement of information encoded by measure qubits.

FIG. 8 depicts an example quantum computer.

Like reference numbers and designations in the various drawings indicate like elements.

### DETAILED DESCRIPTION

An iSWAP gate is a two-qubit quantum logic gate that implements a XX+YY interaction, where application of a iSWAP gate swaps the states of two qubits and phases amplitudes of the states |01 [symbol] and |10 [symbol] by i. In matrix representation the iSWAP gate is given by

$$iSWAP = {R}_{XX + YY} ( - π / 2 ) = exp ( i \frac{π}{4} ( X ⊗ X + Y ⊗ Y ) ) = ( \begin{matrix}1 & 0 & 0 & 0 \\ 0 & 0 & i & 0 \\ 0 & i & 0 & 0 \\ 0 & 0 & 0 & 1\end{matrix} ) .$$

Some quantum hardware can perform iSWAP gates more efficiently and reliably compared to other two-qubit gates such as CNOT or CZ gates. For example, iSWAP gates typically introduce less calibration constraints than CZ gates. However, the action of an iSWAP gate is similar to the action of a CZ gate combined with a SWAP gate. Therefore, applications of iSWAP gates to a patch of qubits moves information encoded by the patch of qubits to other qubits, deforming the logical layout of the patch as it runs. It then becomes difficult to monitor where the information is encoded and how operate or join patches of qubits.

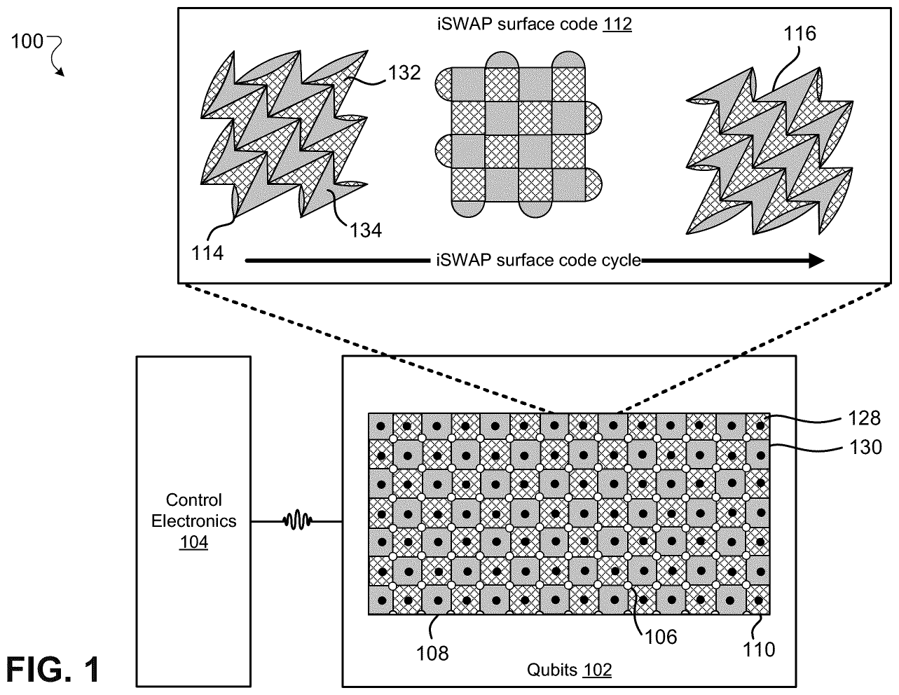

This specification describes techniques for implementing the surface code using iSWAP gates, e.g., instead of CZ or CNOT gates. The techniques include a quantum circuit schedule of iSWAP gates that implements a surface code cycle. The circuit schedule is designed such that logical movement of qubits (i.e., movement of information in the qubit array) is reduced, reducing the amount of qubit padding needed for the information to drift into. Further, the circuit schedule alternates between two different surface code cycles such that the logical movement of qubits oscillates around a center position and does not drift in one direction. FIG. 1 is a block diagram of an example system for implementing an iSWAP surface code. The example system 100 is an example of a system implemented as part of a quantum computing device in which the systems, components and techniques described in this specification can be implemented.

The system 100 includes multiple qubits 102 in communication with control electronics 104. The qubits 102 are physical qubits, e.g., physical devices that behave as quantum systems with at least two states. Each qubit can be in a respective quantum state that occupies one or more levels. The levels can include at least two computational levels, e.g., levels 0- and 1-, and one or more non-computational levels that are each higher than the computational qubit levels, e.g., levels 2- and 3-. Population of the higher, non-computational qubit levels can introduce errors in algorithmic operations or quantum computations performed using the qubit. For example, the occupation of qubit levels outside the computational subspace can hamper or prevent the implementation of quantum error correction operations.

In some implementations the qubits 102 can be superconducting qubits or semiconducting qubits. For example, the qubits 102 can include Xmon qubits, flux qubits, phase qubits, or qubits with frequency interactions. Generally, the qubits 102 are physical devices that are configured to meet basic requirements for quantum computation. For example, the qubits 102 include physical devices that can be initialized, can perform single-qubit rotations, can participate in two-qubit entangling operations, e.g., iSWAP, CZ, CNOT, gates, can perform a topological version of the Hadamard transformation, e.g., by exchanging their quantum states in a SWAP operation, and can be measured.

The qubits 102 can be arranged in an array. For example, as shown in FIG. 1, in some implementations the qubits 102 can be arranged as a two dimensional array, such as a square grid 110. The example two dimensional grid 110 depicted in FIG. 1 includes 11×7=77 qubits, however in some implementations the system 100 may include a smaller or a larger number of qubits.

The qubits 102 can interact with each other through multiple qubit couplers. The qubit couplers can define nearest neighbor interactions between qubits, e.g., such that in a square grid each qubit interacts with at most four neighboring qubits. The couplers can, in principle, be any type of coupler, e.g., a capacitive or inductive coupler. In some implementations the strengths of the couplers can be controllable, e.g., frequency controllable. In other implementations the couplers can be couplers with a fixed coupling strength.

The control electronics 104 include control devices, e.g., arbitrary waveform generators, that can operate the multiple qubits 102. For example, the control electronics 104 can include control devices that tune operating frequencies of the qubits 102 by applying control signals, e.g., voltage pulses, to the qubits through respective control lines.

As another example, the control electronics 104 can control individual frequencies of the qubits 102 such that the frequency of one or more of the qubits are adjusted towards or away from a frequency of an excitation pulse generated by an excitation pulse generator on an excitation driveline. The excitation pulses can include pulses with frequencies that implement quantum operations, e.g., quantum logic gates. The qubits 102 can be coupled to one or more excitation drivelines via respective couplers. In some cases the couplers can be capacitive couplers, e.g., realized by a microwave line running adjacent to a qubit capacitor.

The control electronics 104 can also include control devices that tune frequencies of the couplers that couple the multiple qubits 102.

The type of control electronics 104 that the system 100 utilizes is dependent on the type of qubits the system uses. As an example, qubits that are realized via atomic, molecular or solid-state quantum systems typically have energy separation of the relevant qubit levels in the microwave or optical domain. The states of such qubits may be manipulated and controlled using external fields, such as microwave or optical fields. In such cases, as an example, mode-locked lasers may serve as control electronics due to their broad-band optical spectra that feature both radio frequency and microwave structure. In another example, the control electronics 104 could include a collection of individual qubit controllers realized by a radio frequency generator as well as one or a collection of global excitation controllers realized by a radio frequency or microwave generator. In both cases, the control electronics 104 can be operated manually or connected to a computer (e.g., a classical computer) and controlled via suitable software allowing for specifying and automatically running the required qubit operations.

The system 100 can program the control electronics 104 to implement the surface code. To implement the surface code, each qubit in the multiple qubits 102 has one of two functional types: data qubits, e.g., qubit 106, and measure qubits, e.g., qubit 108. A data qubit, e.g., qubit 106, is a qubit that participates in quantum computations performed by the system 100 and stores quantum information corresponding to the quantum computations. That is, the state of the data qubit encodes logical information for a quantum computation. A measure qubit is a qubit that is used to determine an outcome of a computation performed by the data qubit. For example, during a computation an unknown state of the data qubit can be entangled with the state of the measure qubit using a suitable physical operation, after which the measure qubit can be measured. The measure qubits can include measure-X qubits, e.g., measure qubits located in centers of light grey squares such as square 128, and measure-Z qubits, e.g., measure qubits located in centers of dark grey squares such as square 130.

Each data qubit is directly coupled to multiple measure qubits (and is not directly coupled to any other data qubits) and each measure qubit is directly coupled to multiple data qubits (and is not directly coupled to any other measure qubits). For example, each measurement qubit is coupled to four data qubits (if the measure qubit is in the bulk, if it is at the boundary it is coupled to less data qubits). Each data qubit is coupled to two measure-Z qubits and to two measure-X qubits (if the data qubit is at in the bulk, if the data qubit is at the boundary it is coupled to less measure qubits).

A measure-Z qubit is a qubit that can be used to force its neighboring data qubits a, b, c and d into an eigenstate of the operator product ZaZZ_{d} where Zₐ represents a Pauli-Z operator acting on qubit a. Each measure-Z qubit is therefore described as measuring a ZZZZ stabilizer. In the example array 102 of FIG. 1, ZZZZ stabilizers are represented by the darker grey squares, e.g., square 130, where data qubits exist at the vertices of the ZZZZ stabilizers and measure-Z qubits exist at the center of each ZZZZ stabilizer. A measure-X qubit is a qubit that can be used to force its neighboring data qubits a, b, c and d into an eigenstate of the operator product XₐXbXcX_{d} where Xₐ represents a Pauli-X operator acting on qubit a. Each measure-X qubit is therefore referred to as measuring a XXXX stabilizer. In the example array 102 of FIG. 1, XXXX stabilizers are represented by the lighter grey squares, e.g., square 128, where data qubits exist at the vertices of the XXXX stabilizers and measure-X qubits exist at the center of each XXXX stabilizer.

In conventional implementations of the surface code (different to the implementations described in this disclosure), the control electronics 104 operate the measure-Z and measure-X qubits by repeatedly applying a quantum circuit to the measure-Z and measure-X qubits and their neighboring data qubits. Each application of a quantum circuit performs one surface code cycle. Each quantum circuit includes a sequence of operations applied to one or more physical qubits. In examples, first the measure qubit is reset, e.g., in its ground state. Then, four entangling operations, e.g., CNOT gates or CZ gates, are performed. For a measure-Z qubit, each of the four entangling operations targets the measure qubit and each nearest-neighbor data qubit acts as a control for a respective entangling operation. For a measure-X qubit, each of the four entangling operations targets a respective nearest-neighbor data qubit and the measure-X qubit acts as a control for each of the four entangling operations. In this case, the sequence of operations also includes a Hadamard gate applied to the measure qubit before and after the entangling operations. After the entangling operations are performed, the measure qubit is measured, e.g., through projective measurement. Following measurement, a subsequent surface code cycle is performed.

Unlike conventional implementations of the surface code, the presently described implementations of the surface code use iSWAP gates instead of CNOT or CZ gates. The presently described surface code is therefore referred to herein as an iSWAP surface code 112.

As described in more detail below, an iSWAP surface code cycle also includes four layers of entangling operations, where each of the four layers includes iSWAP gates. The first layer of entangling operations is applied to the qubits included in the surface code patch after the measure qubits in the surface code patch have been reset. Therefore, as described in more detail below, the first layer of entangling operations can be designed such that it is exactly equivalent to a CZ gate (and can be made exactly equivalent to a CNOT gate by including additional Hadamard gates and using the relation HZH=X, where H represents a Hadamard gate, Z represents a Pauli-Z gate, and X represents a Pauli-X gate). The fourth layer of entangling operations is applied to the qubits included in the surface code patch before measure qubits included in the surface code patch are measured. Therefore, as described in more detail below, the fourth layer of entangling operations can also be designed such that it is exactly equivalent to a CZ gate or CNOT gate (with a frame change that is tracked by classical control hardware). Application of the four layers of entangling operations moves the information encoded by the qubits included in the surface code patch, e.g., as illustrated by the deformed surface code patches 114 and 116 (where in the illustrated surface code patches lighter grey shapes, e.g., shape 132, represent XXXX stabilizers and darker grey shapes, e.g., shape 134, represent ZZZZ stabilizers.) Therefore, sequential iSWAP surface code cycles alternate between running the cycle forwards and running the cycle backwards, so that the information does not keep moving in a same direction.

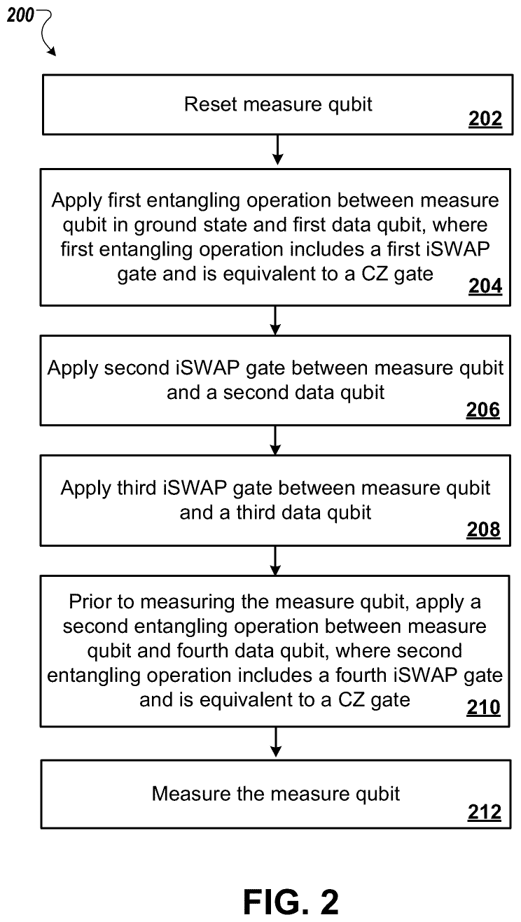

FIG. 2 is a flowchart of an example process 200 for performing an iSWAP surface code cycle. For convenience, the process 200 will be described as being performed by components of a quantum computing system. For example, classical control electronics in communication with an array of physical qubits, e.g., the control electronics 104 of FIG. 1, appropriately programmed, can perform example process 200.

For clarity, example process 200 is described with reference to performing an iSWAP surface code cycle on one (bulk) measure qubit that is coupled to four data qubits. However, example process 200 can be performed (in parallel) for each of multiple data qubits and their neighboring measure qubits included in a surface code patch.

The system applies a reset operation to the measure qubit to reset the measure qubit in the ground state (step 202).

The system applies a first entangling operation between the measure qubit in the ground state and a first data qubit (step 204). The first entangling operation is a sequence of gates that includes a first iSWAP gate and one or more single qubit gates, where the one or more single qubit gates are determined such that a result of application of the first entangling operation is equivalent to a result of applying a CZ gate between the measure qubit in the ground state and the first data qubit.

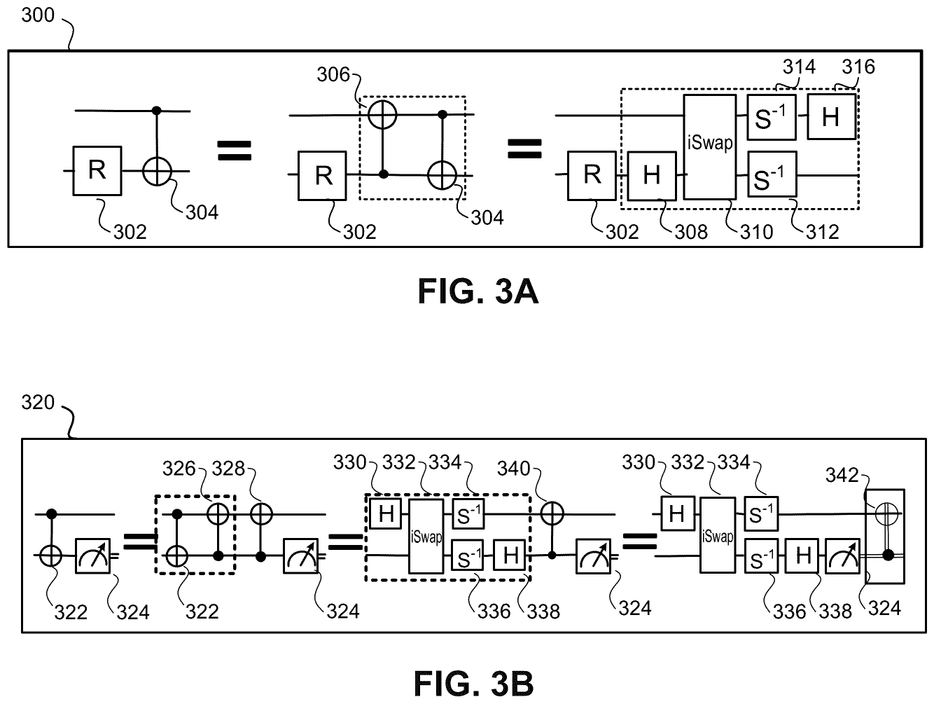

FIG. 3A shows an example quantum circuit 300 that implements the first entangling operation. As shown in FIG. 3A, when an iSWAP gate is applied to a qubit that has been reset, it acts as a controlled Paul gate. For example, applying a reset operation 302 to a first qubit followed by a first CNOT gate 304 between the first qubit and a second qubit (where the second qubit acts as a control) is equivalent to applying the reset operation 302, applying a second CNOT gate 306 to the first qubit and the second qubit (where the first qubit acts as a control), and applying the first CNOT gate 304 after the second CNOT gate 306. This is because after the reset operation 302, the first qubit is known to be in a 0-state, and therefore the CNOT gate has no effect on the second qubit (since a CNOT gate flips a target qubit state if and only if the control qubit is in a 1-state). In other words, a result of applying operation 302 followed by operation 304 is the same as a result of applying operation 302, followed by operation 306, followed by operation 304.

According to Cartan's KAK decomposition, the sequential application of two CNOT gates on the same two qubits (where the controls for the CNOT gates differ) has a same interaction as an iSWAP gate. Therefore, single qubit gates can be added before and after the two CNOT gates to obtain a gate sequence that is equivalent to an iSWAP gate. Likewise, single qubit gates can be added before and after an iSWAP gate to obtain a gate sequence that is exactly equivalent to sequential application of two CNOT gates (or two CZ gates) on the same two qubits (where the controls for the CNOT or CZ gates differ). For example, as shown in FIG. 3A, sequential application of CNOT gates 306 and 304 is equivalent to application of: a first Hadamard gate 308 on the first qubit, application of an iSWAP gate 310 between the first qubit and the second qubit, application of inverse S gates 312 and 314 to the first qubit and second qubit, respectively, and application of a second Hadamard gate 316 to the second qubit.

Returning to FIG. 2, the system applies a second iSWAP gate between the measure qubit and a second data qubit (step 206).

The system applies a third iSWAP gate between the measure qubit and a third data qubit (step 208).

The system applies a second entangling operation between the measure qubit and a fourth data qubit (step 210). The second entangling operation is a sequence of gates that includes a fourth iSWAP gate and one or more single qubit gates, where the one or more single qubit gates are determined such that a result of application of the second entangling operation is equivalent to a result of applying a CZ gate between the measure qubit in the ground state and the fourth data qubit.

FIG. 3B shows an example quantum circuit 320 that implements the second entangling operation. As shown in FIG. 3B, when an iSWAP gate is applied before a measurement operation, it acts as a controlled Paul gate. For example, applying a CNOT gate 322 to a first qubit and a second qubit (where the first qubit acts as a control) followed by a measurement operation 324 on the second qubit is equivalent to applying the CNOT gate 322, followed by two CNOT gates 326, 328 (where the second qubit acts as a control), followed by the measurement operation 324 on the second qubit. This is because the square of a Pauli matrix is the identity matrix, therefore sequential application of a same controlled Pauli gate to two qubits has no effect on the two qubits. In other words, a result of applying operation 322 followed by operation 324 is the same as a result of applying operation 322, followed by operation 326, followed by operation 328, followed by operation 324.

As described above with reference to FIG. 3A, the sequential application of two CNOT gates on the same two qubits (where the controls for the CNOT gates differ) has a same interaction as an iSWAP gate. Therefore, single qubit gates can be added before and after the two CNOT gates to obtain a gate sequence that is equivalent to an iSWAP gate. Likewise, single qubit gates can be added before and after an iSWAP gate to obtain a gate sequence that is exactly equivalent to sequential application of two CNOT gates (or two CZ gates) on the same two qubits (where the controls for the CNOT or CZ gates differ). For example, as shown in FIG. 3B, sequential application of CNOT gates 322 and 326 is equivalent to application of: a first Hadamard gate 330 on the first qubit, application of an iSWAP gate 332 between the first qubit and the second qubit, application of inverse S gates 334 and 336 to the first qubit and second qubit, respectively, and application of a second Hadamard gate 338 to the second qubit.

This leaves CNOT gate 340. However, since the second qubit only acts as a control in the CNOT gate 430, the CNOT gate 340 can be applied after the measurement operation 324 is performed on the second qubit, e.g., as a classically controlled NOT operation 342. In quantum error correction circuits, Pauli feedback does not need to be performed in real time and can be handled by post-processing of measurement results. That is, during the surface code cycle the controlled NOT operation 342 need not be performed.

Returning to FIG. 2, the system measures the measure qubit (step 212). A result of the measurement can be used to detect errors in the quantum computation being performed by the data qubits.

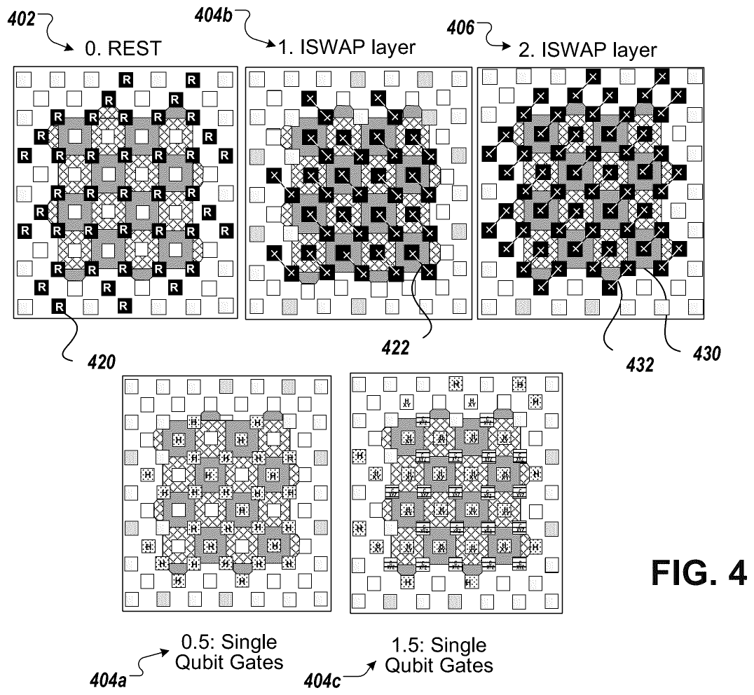

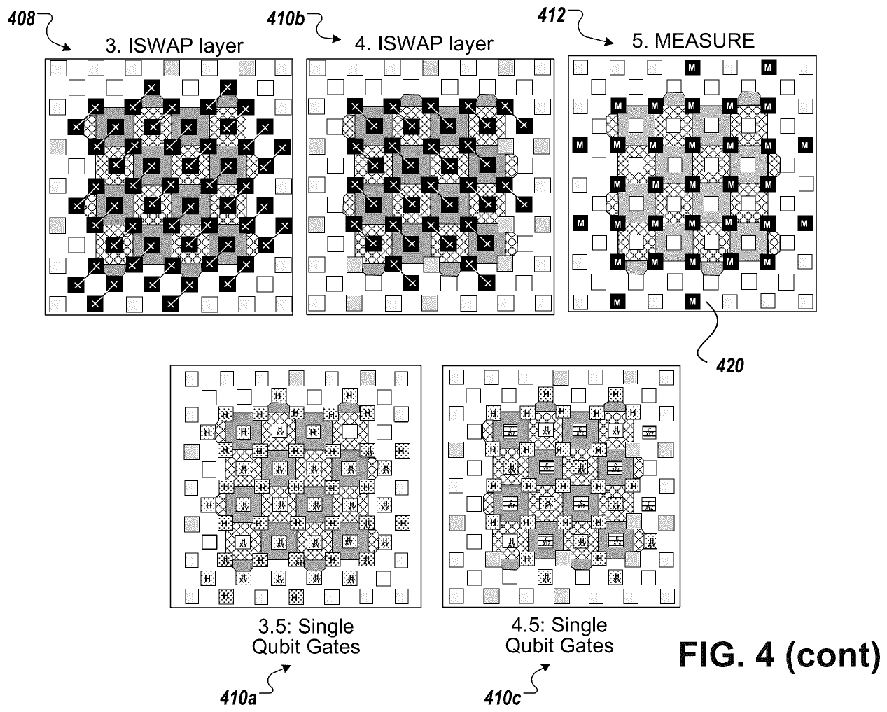

FIG. 4 illustrates example quantum circuit layers for performing an iSWAP surface code cycle. The illustration of layer 402 corresponds to step 202 in example process 200 of FIG. 2 and shows each measure qubit in the surface code patch being reset, e.g., through application of reset operations such as reset operation 420. In the illustration of each layer, qubits located at the center of the darker grey squares, e.g., square 430, and lighter grey squares, e.g., square 432, represent data qubits and the qubits located at the vertices of the darker grey squares, e.g., square 430, and lighter grey squares, e.g., square 432, represent measure qubits.

The illustration of layer 404a-c corresponds to step 204 in example process 200 of FIG. 2 and shows a layer of first entangling operations being applied to respective measure qubits and data qubits that are coupled to the measure qubits in a first direction (in this example in a north-west direction). As described above with reference to FIG. 2, the layer of first entangling operation includes a layer of iSWAP gates 404b, including, e.g., iSWAP gate 422. The layer of first entangling operation also includes a first layer of single qubit gates 404a that are applied to both measure and data qubits included in the surface code patch and a second layer of single qubit gates 404c that are applied to both measure and data qubits included in the surface code patch.

The illustrations of layers 406 and 408 correspond to steps 206 and 208 in example process 200 of FIG. 2 and show two layers of iSWAP gates being applied to respective measure qubits and data qubits that are coupled to the measure qubits in a second and third direction. The second and third directions are parallel to each other and perpendicular to the first direction (in this example the second and third directions are north-east and south-west, respectively).

The illustration of layer 410a-c corresponds to step 210 in example process 200 of FIG. 2 and shows a layer of second entangling operations being applied to respective measure qubits and data qubits that are coupled to the measure qubits in a fourth direction. The fourth direction is parallel to the first direction (in this example in a south-east direction). As described above with reference to FIG. 2, the layer of second entangling operation includes a layer of iSWAP gates 410b. The layer of second entangling operation also includes a first layer of single qubit gates 410a that are applied to both measure and data qubits included in the surface code patch and a second layer of single qubit gates 410c that are applied to both measure and data qubits included in the surface code patch. In layers 404a, 404c, 410a, and 410c the single qubit gates are labelled as “H”, “HXY”, or “CXYZ”.

The illustration of layer 412 corresponds to step 212 in example process 200 of FIG. 2 and shows each measure qubit in the surface code patch being measured, e.g., through application of measurement operations such as measurement operation 420.

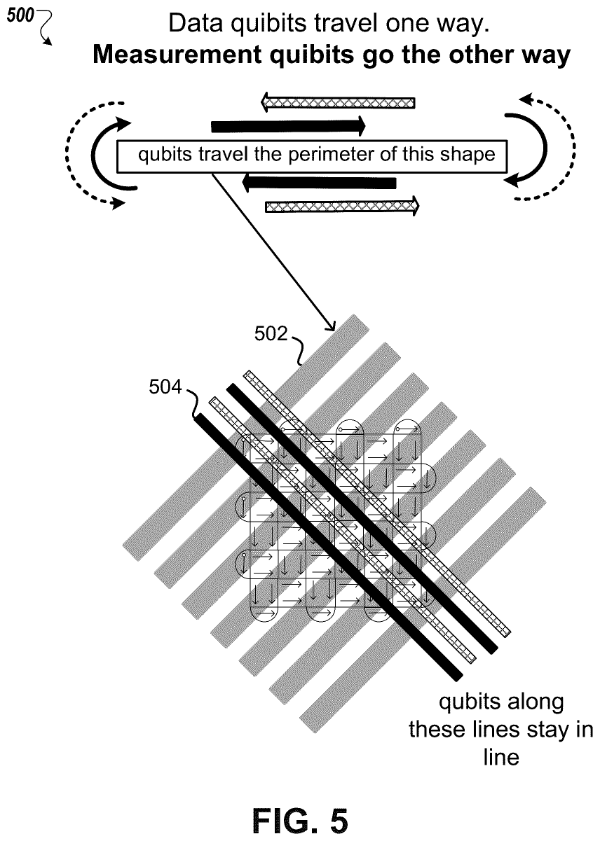

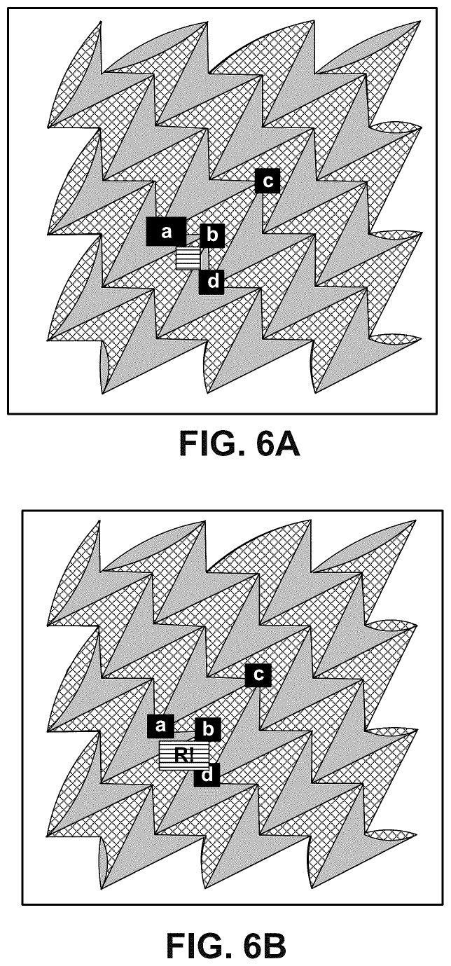

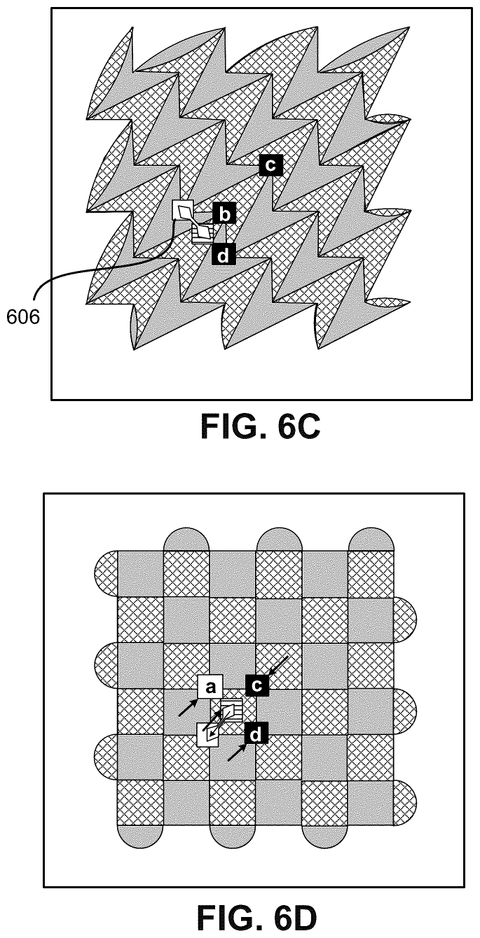

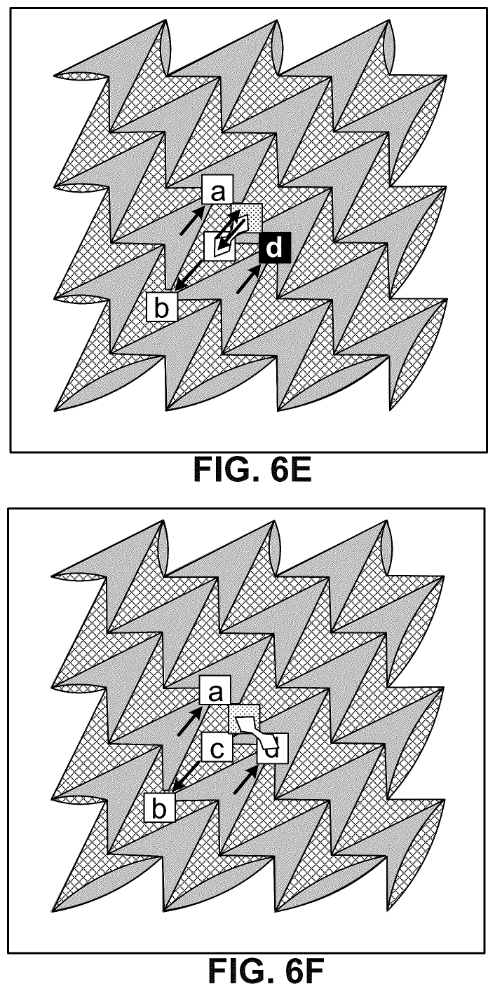

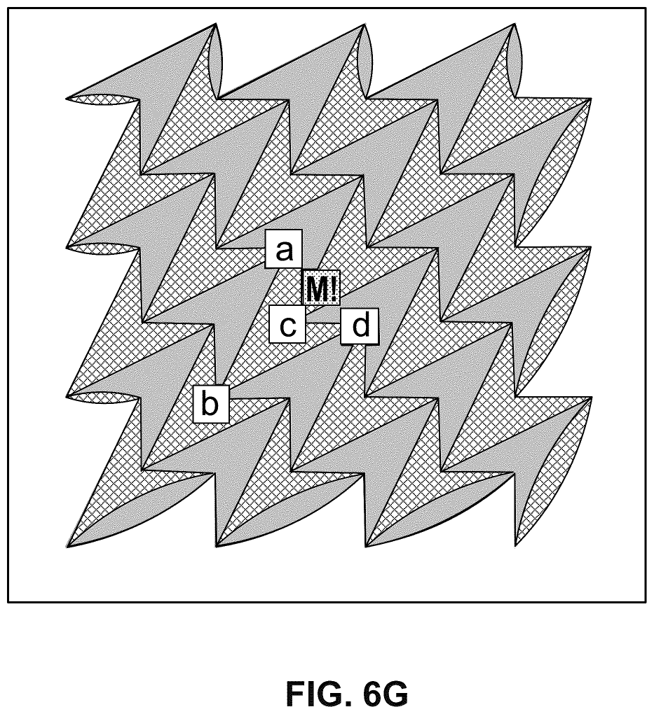

As described above with reference to FIG. 1, application of the four layers of entangling operations 404, 406, 408, and 410 moves information encoded by the qubits included in the surface code patch to other qubits in the grid. FIG. 5 is an illustration that shows how information encoded by qubits included in the surface code patch moves. For illustrative purposes, FIG. 5 (and FIGS. 6A-G) describes the movement of information in terms of moving qubits. However, in physical implementations the physical qubits remain in the same position in the grid and it is the information stored by the physical qubits that move.

By construction, during the first surface code cycle, the measure qubits included in the surface code patch move in a first direction. The data qubits move in a second direction, where the second direction is opposite to the first direction. This movement forms “conveyor belts” of moving qubits, e.g., conveyor belt 502, where the conveyor belts of moving qubits move collectively/together. As the conveyor belts of qubits move, in this example on a diagonal line that extends from the bottom left of the grid to the top right of the grid, qubits on lines with a third direction that is perpendicular to the direction that the conveyor belts extend, e.g., line 504, collectively move and stay in line. That is, their positions with respect to one another does not change. In other words, measure qubits stay next to their perpendicular-to-conveyor data qubits and travel “through” their along-conveyor data qubits.

This means that if the first surface code cycle described with reference to FIGS. 2 and 4 is repeated, the measure and data qubits will continue to move in a same direction so that the surface code patch will pull further and further apart until it is destroyed. Therefore, the iSWAP surface code alternates between running the first surface code cycle forwards (as described with reference to FIGS. 2 and 4) and backwards (i.e., in reverse order).

For example, two sequential cycles of the iSWAP surface code can be performed as follows: reset the measure qubits, perform CZ-style entangling operations to interact with first data qubits, step conveyors forward one step, where the second data qubits and measure qubits interact as they cross, step conveyors forward one step, where third data qubits and measure qubits interact as they cross, perform CZ-style entangling operations to interact with fourth data qubits, measure the measure qubits, reset the measure qubits, perform CZ-style entangling operations to interact with first data qubits, step conveyors backward one step, where the second data qubits and measure qubits interact as they cross, step conveyors backward one step, where third data qubits and measure qubits interact as they cross, perform CZ-style entangling operations to interact with fourth data qubits, and measure the measure qubits. The movement of a measure qubit and its neighboring data qubits is illustrated and described below with reference to FIGS. 6A-G.

FIGS. 6A-G illustrate interactions performed by a measure qubit and tracks the movement of information accumulated by the measurement. FIG. 6A shows a measure qubit (square 602) that is coupled to four data qubits a, b, c, and d (e.g., square 504, where squares representing data qubits turn a lighter shade of grey after interaction with the measure qubit as shown in square 606 of FIG. 6C). FIG. 6A corresponds to an output of a previous iSWAP surface code cycle, which is why the data qubit “c” is not next to the measure qubits. In FIG. 6B, the measure qubit is reset. This illustration corresponds to step 202 in example process 200 of FIG. 2.

In FIG. 6C, the reset measure qubit interacts with data qubit “a” using the first entangling operation described above with reference to FIGS. 2 and 3. In this example data qubit “a” is above and to the left of the measure qubit.

In FIG. 6D, the measure qubit interacts with data qubit “b” using an iSWAP gate. In this example the data qubit “b” is perpendicular to data qubit “a” and is below and to the left of the measure qubit. The interaction between the measure qubit and data qubit “b” causes the measure qubits “b” and “c” to move in a first direction (south-west) such that the measure qubit crosses the data qubit “b”. The measure qubit, data qubit “a” and data qubit “d” move in an opposite direction (north east) and stay in line.

In FIG. 6E the measure qubit interacts with data qubit “c” using an iSWAP gate. This causes the measure qubits “b” and “c” to move in a first direction (south-west) such that the measure qubit crosses the data qubit “c”. The measure qubit, data qubit “a” and data qubit “d” move in an opposite direction (north east) and stay in line.

In FIG. 6F the measure qubit interacts with data qubit “d” using the second entangling operation described above with reference to FIGS. 2 and 3. In this example data qubit “d” is below and to the right of the measure qubit. In FIG. 6G the measure qubit is measured.

In a subsequent iSWAP surface code cycle, the same operations are repeated but in reverse. For example, the measure qubit is reset. The reset measure qubit interacts with data qubit “d” using the first entangling operation. The measure qubit interacts with qubit “c” using an iSWAP gate and then interacts with qubit “b” using an iSWAP gate. The measure qubit then interacts with qubit “a” using the second entangling operation before it is measured. These alternating forwards and backwards cycles can be repeated as necessary.

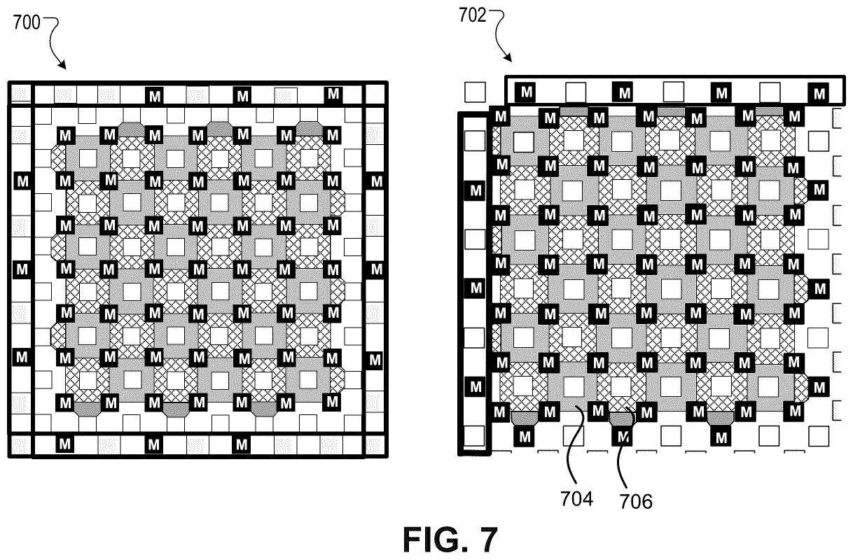

FIG. 7 shows example qubit grid paddings for the movement of information encoded by measure qubits. In the first example qubit grid padding 700 two extra rows and columns of qubits are added, one for each side of the square grid. This effectively reduces the placeable code distance by 1. In the second example qubit grid padding 702 one (shorter) row and one (shorter) column are added. If it is possible to measure a subset of a readout line, no padding is needed. In FIG. 7, qubits located at the center of the darker grey squares, e.g., square 704, and lighter grey squares, e.g., square 706, represent data qubits and the qubits located at the vertices of the darker grey squares, e.g., square 704, and lighter grey squares, e.g., square 706, represent measure qubits.

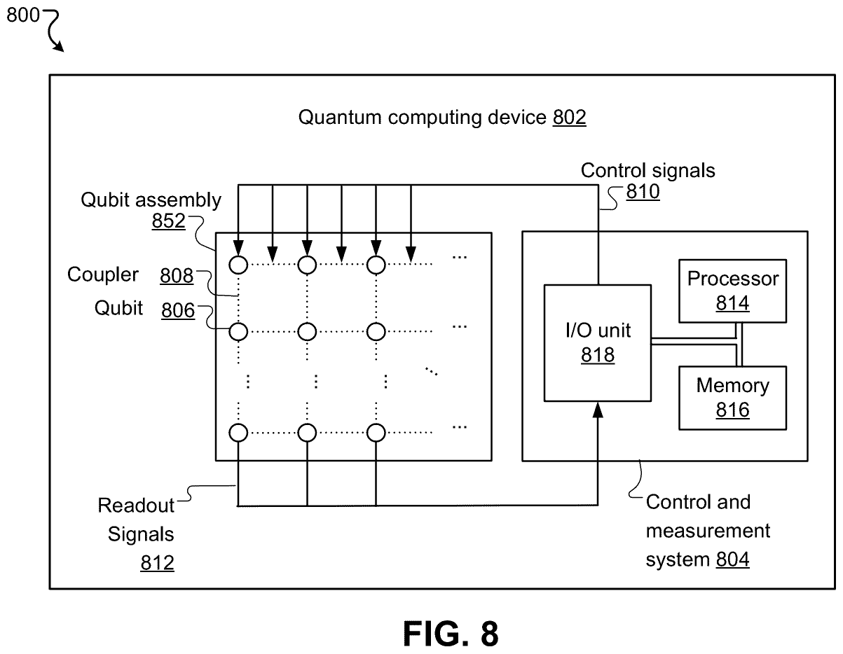

FIG. 8 depicts an example quantum computer 800 for performing the quantum operations described in this specification. The example quantum computer 800 includes an example quantum computing device 802. The quantum computing device 802 is intended to represent various forms of quantum computing devices. The components shown here, their connections and relationships, and their functions, are exemplary only, and do not limit implementations of the inventions described and/or claimed in this document.

The example quantum computing device 802 includes a qubit assembly 852 and a control and measurement system 804. The qubit assembly includes multiple physical qubits, e.g., qubit 806, that are used to perform algorithmic operations or quantum computations. While the qubits shown in FIG. 8 are arranged in a rectangular array, this is a schematic depiction and is not intended to be limiting. The qubit assembly 852 also includes adjustable coupling elements, e.g., coupler 808, that allow for interactions between coupled qubits. In the schematic depiction of FIG. 8, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 802 included in the example computer 800 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the surface code circuits described in this specification. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT), iSWAP gates, and gates involving three or more qubits, e.g., Toffoli gates. The quantum logic gates can be implemented by applying control signals 810 generated by the control and measurement system 804 to the qubits and to the couplers.

For example, in some implementations the qubits in the qubit assembly 852 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 810 used depends on the physical realizations of the qubits.

For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 810. The measurements cause readout signals 812 representing measurement results to be communicated back to the measurement and control system 804. The readout signals 812 may include RF, microwave, or optical signals depending on the physical scheme for the quantum computing device and/or the qubits. For convenience, the control signals 810 and readout signals 812 shown in FIG. 8 are depicted as addressing only selected elements of the qubit assembly (i.e., the top and bottom rows), but during operation the control signals 810 and readout signals 812 can address each element in the qubit assembly 852.

The control and measurement system 804 is an example of a classical computer system that can be used to perform various operations on the qubit assembly 852, as described above, as well as other classical subroutines or computations. The control and measurement system 804 includes one or more classical processors, e.g., classical processor 814, one or more memories, e.g., memory 816, and one or more I/O units, e.g., I/O unit 818, connected by one or more data buses. The control and measurement system 804 can be programmed to send sequences of control signals 810 to the qubit assembly, e.g., to carry out a selected series of quantum gate operations, and to receive sequences of readout signals 812 from the qubit assembly, e.g., as part of performing measurement operations.

The processor 814 is configured to process instructions for execution within the control and measurement system 804. In some implementations, the processor 814 is a single-threaded processor. In other implementations, the processor 814 is a multi-threaded processor. The processor 814 is capable of processing instructions stored in the memory 816.

The memory 816 stores information within the control and measurement system 804. In some implementations, the memory 816 includes a computer-readable medium, a volatile memory unit, and/or a non-volatile memory unit. In some cases, the memory 816 can include storage devices capable of providing mass storage for the system 804, e.g., a hard disk device, an optical disk device, a storage device that is shared over a network by multiple computing devices (e.g., a cloud storage device), and/or some other large capacity storage device.

The input/output device 818 provides input/output operations for the control and measurement system 804. The input/output device 818 can include D/A converters, A/D converters, and RF/microwave/optical signal generators, transmitters, and receivers, whereby to send control signals 810 to and receive readout signals 812 from the qubit assembly, as appropriate for the physical scheme for the quantum computer. In some implementations, the input/output device 818 can also include one or more network interface devices, e.g., an Ethernet card, a serial communication device, e.g., an RS-232 port, and/or a wireless interface device, e.g., an 802.8 card. In some implementations, the input/output device 818 can include driver devices configured to receive input data and send output data to other external devices, e.g., keyboard, printer and display devices.

Although an example control and measurement system 804 has been depicted in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature.

Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a quantum computer, the method comprising:
performing a first surface code cycle in a system comprising a plurality of physical qubits arranged on a grid, wherein performing the first surface code cycle comprises:
applying a first entangling operation between a measure qubit in a ground state and a first data qubit, wherein the first entangling operation comprises a first iSWAP gate in sequence with the application of at least one other operation such that a result of applying the first entangling operation between the measure qubit in the ground state and the first data qubit is equivalent to a result of applying a CZ gate between the measure qubit in the ground state and the first data qubit;
applying a second iSWAP gate between the measure qubit and a second data qubit;
applying a third iSWAP gate between the measure qubit and a third data qubit;
applying a second entangling operation between the measure qubit and a fourth data qubit, wherein the second entangling operation comprises a fourth iSWAP gate in sequence with the application of at least one other operation such that a result of applying the second entangling operation to the measure qubit and the fourth data qubit is equivalent to a result of applying a CZ gate between the measure qubit and the fourth data qubit; and
measuring the measure qubit to detect errors.

2. The method of claim 1, wherein applying the first entangling operation further comprises applying one or more single qubit gates to the measure qubit and to the first data qubit.

3. The method of claim 2, wherein applying one or more single qubit gates to the measure qubit comprises applying a Hadamard gate to the measure qubit prior to applying the first iSWAP gate.

4. The method of claim 2, wherein applying one or more single qubit gates to the measure qubit and to the first data qubit comprises, after applying the first iSWAP gate:
applying an inverse S-gate to the measure qubit and to the first data qubit; and
applying a Hadamard gate to the first data qubit.

5. The method of claim 1, wherein applying the second entangling operation comprises, prior to applying the fourth iSWAP gate, applying a Hadamard gate to the fourth data qubit.

6. The method of claim 1, wherein applying the second entangling operation comprises, after applying the fourth iSWAP gate:
applying an inverse S-gate to the measure qubit and the fourth data qubit; and
applying a Hadamard gate to the measure qubit.

7. The method of claim 6, wherein measuring the measure qubit to detect error comprises using a result of a classically controlled NOT operation.

8. The method of claim 1, further comprising, prior to applying the first entangling operation, applying a reset operation to the measure qubit to reset the measure qubit in the ground state.

9. The method of claim 1, wherein performing the first surface code cycle moves information encoded by the measure qubit and the first data qubit, second data qubit, third data qubit, and fourth data qubit to other qubits in the grid.

10. The method of claim 9, wherein information encoded by the measure qubit moves to other qubits in the grid in a first direction and information encoded by one or more of the first data qubit, second data qubit, third data qubit, or fourth data qubit moves to other qubits in the grid in a second direction, wherein the second direction is opposite to the first direction.

11. The method of claim 10, wherein information encoded by the measure qubit and data qubits coupled to the measure qubit in a third direction that is perpendicular to the first direction collectively moves in the grid.

12. The method of claim 1, further comprising performing a second surface code cycle, wherein performing the second surface code cycle comprises performing the first surface code cycle in reverse order.

13. A quantum computing apparatus comprising:
a plurality of physical qubits arranged on a grid;
qubit couplers defining nearest neighbor interactions between the plurality of qubits; and
control electronics configured to operate the plurality of qubits and qubit couplers, wherein the control electronics are configured to perform operations for implementing one or more surface code cycles, the operations comprising:
performing a first surface code cycle in a system comprising a plurality of physical qubits arranged on a grid, wherein performing the first surface code cycle comprises:
applying a first entangling operation between a measure qubit in a ground state and a first data qubit, wherein the first entangling operation comprises a first iSWAP gate in sequence with the application of at least one other operation such that a result of applying the first entangling operation between the measure qubit in the ground state and the first data qubit is equivalent to a result of applying a CZ gate between the measure qubit in the ground state and the first data qubit;
applying a second iSWAP gate between the measure qubit and a second data qubit;
applying a third iSWAP gate between the measure qubit and a third data qubit;
applying a second entangling operation between the measure qubit and a fourth data qubit, wherein the second entangling operation comprises a fourth iSWAP gate in sequence with the application of at least one other operation such that a result of applying the second entangling operation to the measure qubit and the fourth data qubit is equivalent to a result of applying a CZ gate between the measure qubit and the fourth data qubit; and
measuring the measure qubit to detect errors.
